(19) United States
(12) Patent Application Publication
(10) Pub. No.: US 2017/0324967 A1
(43) Pub. Date: Nov. 9, 2017

(54) METHOD FOR CONTROLLING BITSTREAM DECODING AND ASSOCIATED BITSTREAM DECODING CIRCUIT

(71) Applicant: MStar Semiconductor, Inc., Hsinchu Hsien (TW)

(72) Inventors: Ya-Ting Yang, Zhubei City (TW); Yi-Shin Tung, Zhubei City (TW)

(21) Appl. No.: 15/341,123

(22) Filed: Nov. 2, 2016

(30) Foreign Application Priority Data
May 6, 2016 (TW) 105114168

(51) Int. Cl. H04N 19/423; H04N 19/44; H04L 29/06

(52) U.S. Cl. CPC H04N 19/423; H04L 69/22; H04N 19/44; H04L 65/607

(57) ABSTRACT

A method for controlling bitstream decoding is provided. The bitstream includes a plurality of frames. The method includes: generating a performance indicator according to a decoding time of at least one previous frame; generating a dropping decision according to the performance indicator, wherein the dropping decision indicates whether it is needed to drop a frame; and determining whether to drop a current frame according to the dropping decision.

This application claims the benefit of Taiwan application Serial No. 105114168, filed May 6, 2016, the subject matter of which is incorporated herein by reference.

### BACKGROUND OF THE INVENTION

### Field of the Invention

The invention relates in general to a method for controlling bitstream decoding and an associated bitstream decoding circuit, and more particularly, to a method for controlling bitstream decoding that dynamically evaluates the decoding performance and accordingly adaptively determines whether to drop a part of the frames to maintain smooth playback, and an associated bitstream decoding circuit.

### Description of the Related Art

Video playback is one of most important functions of modern electronic products. Video is formed by multiple frames. For convenient storage, the frames are encoded (including being compressed) and centralized in a bitstream. Video playback involves decoding (including decompressing) these frames from the bitstream. However, decoding consumes system resources of an electronic product, including power, memory bandwidth and processor usage. While an electronic product plays video, if frames are difficult to decode (e.g., frames with complex and sophisticated contents), or the electronic product needs to concurrently provide system resources to one or multiple other applications or background services, system resources available for the decoding process may fall short. As a result, the decoding performance is degraded, in a way that frames to be played cannot be timely decoded according to a normal display speed to further affect the smoothness of video playback.

### SUMMARY OF THE INVENTION

It is an object of the present invention to provide a method for controlling bitstream decoding. The bitstream includes a plurality of frames. The method includes: generating a performance indicator according to a decoding time of at least one previous frame; generating a dropping decision according to the performance indicator, wherein the dropping decision indicates whether it is needed to drop a frame; and determining whether to drop a current frame according to the dropping decision.

It is another object of the present invention to provide a bitstream decoding circuit. The bitstream decoding circuit includes a performance monitor, a dropping decider and a decoder. The performance monitor generates a performance indicator according to a decoding time of at least one previous frame. The dropping decider generates a dropping decision according to the performance indicator, wherein the dropping decision indicates whether it is needed to drop a frame. The decoder determines whether to drop a current frame according to the dropping decision.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 are examples of various situations during video playback;

FIG. 2 is a block diagram of a bitstream decoding circuit according to an embodiment of the present invention;

FIG. 3 is a flowchart of a process of generating a performance indicator and a dropping decision according to an embodiment of the present invention;

FIG. 4 is a flowchart of a process of generating a droppable result according to an embodiment of the present invention;

FIG. 5 is a flowchart of a process of generating a droppable result according to another embodiment of the present invention;

FIG. 6 is a flowchart of a process of determining whether to drop a current frame according to an embodiment of the present invention; and

FIG. 7a to FIG. 7c are examples of bitstreams having different structures.

### DETAILED DESCRIPTION OF THE INVENTION

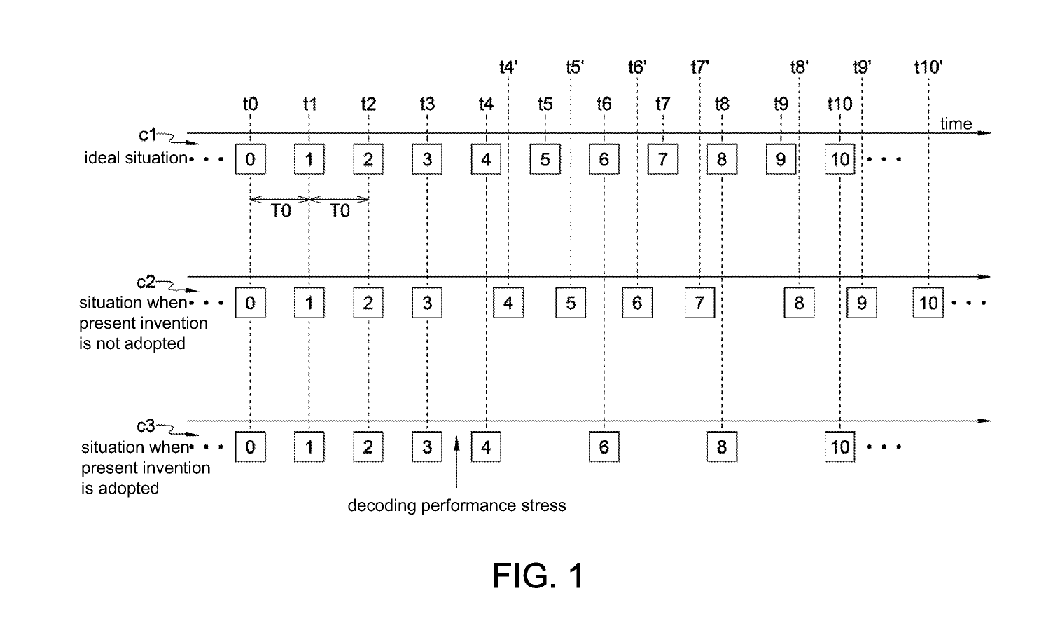

FIG. 1 shows different situations of video playback. Assume that a video includes frames 0 to 10. In an ideal situation, the frames 0 to 10 are expected to be displayed at time points t0 to t10 at a regular interval TO, respectively, as shown by the sequence c1. For example, if the video includes 60 frames per second, the interval TO between two adjacent time points, such as t0 and t1 or t2 and t1, is 1/60 second. However, if decoding performance distress occurs after the time point t3, the frames 4 to 10 are respectively delayed to be displayed at time points t4′ to t10′, respectively, as shown by the sequence c2, instead of being timely displayed at the time points t4 to t10 as expected. Thus, a viewer may notice a momentary stop and lag in the video playback.

To alleviate the effect that the decoding performance stress has on playback smoothness, in the present invention, a performance indicator is calculated to reflect the decoding performance, and certain frames are appropriately dropped and not decoded (nor displayed), such that the remaining frames that are not dropped may be successfully decoded and timely displayed. As shown by the sequence 3, once decoding performance distress is detected after the time point t3, the present invention drops a part of the subsequent frames, e.g., the frames, 5, 7 and 9. As these frames are dropped and not decoded, the remaining frames 6, 8 and 10 are successfully decoded at the time points t6, t8 and t10, respectively, and are timely displayed before or at the time pints t6, t8 and t10. Compared to the sequence c2, in the sequence c3, the frames 6, 8 and 10 are still timely displayed, and so the effect that the decoding performance stress has on the playback smoothness is alleviated.

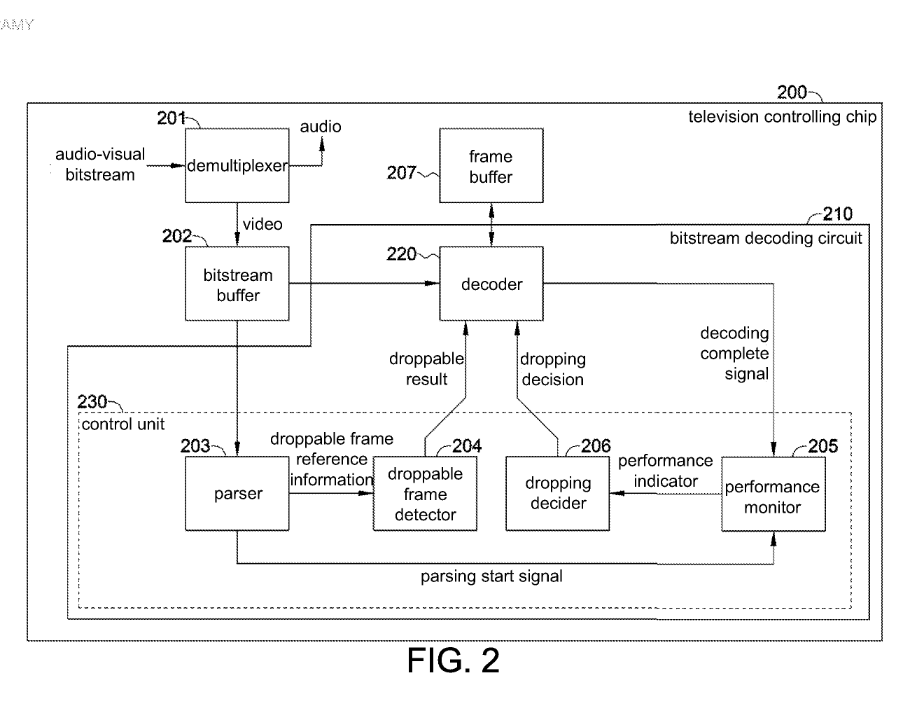

FIG. 2 shows a block diagram of a bitstream decoding circuit 210 according to an embodiment of the present invention. The bitstream decoding circuit 210 may be disposed in a television controlling chip (or a graphic processing chip) 200 to cooperate with a demultiplexer 210 in the television controlling chip 200, and is coupled to a bitstream buffer 202 and a frame buffer 207. The bitstream decoding circuit 210 may include a decoder 220, a parser 203, a droppable frame detector 204, a performance monitor 206 and a dropping decider 206. For example, the decoder 220 may be a hardware decoding circuit; the parser 203, the droppable frame detector 204, the performance monitor 205 and the dropping decider 206 may be implemented by a control unit 230 (e.g., a logic circuit) executing software or firmware codes.

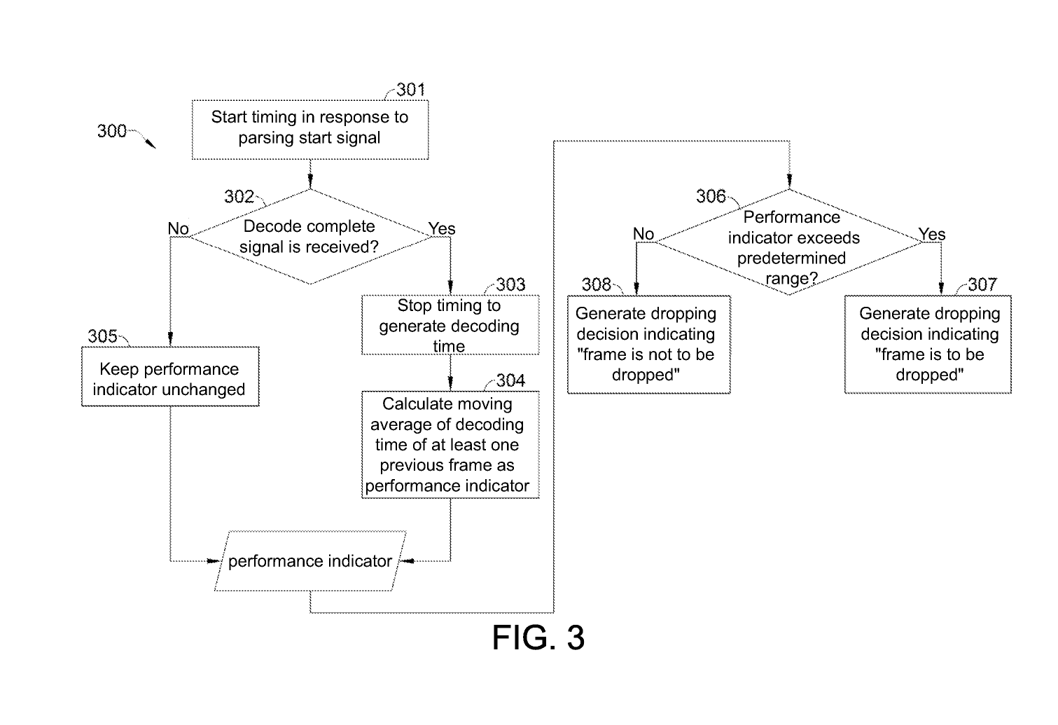

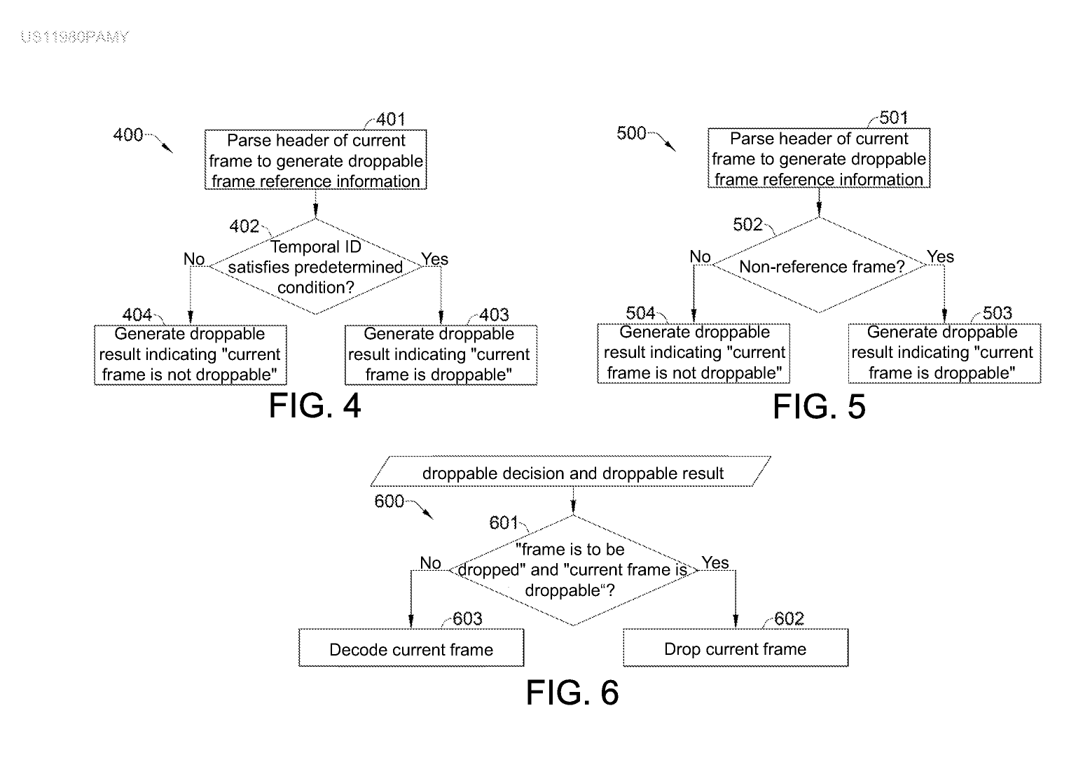

Refer to FIG. 2 as well as FIG. 3 to FIG. 6. An exemplary operation of the performance monitor 205 and the dropping decider 206 may be illustrated by the process 300 in FIG. 3, an exemplary operation of the droppable frame detector 204 may be illustrated by the process 400 in FIG. 4 and the process 500 in FIG. 5, and an exemplary operation of the decoder 220 may be illustrated by the process 600 in FIG. 6.

In the television controlling chip 200, the demultiplexer 201 divides an audio-visual bitstream into an audio bitstream and a video bitstream. The bitstream buffer 202 buffers the video bitstream, which includes a plurality of encoded frames (not shown). The parser 203 and the decoder 220 may access the video bitstream from the bitstream buffer 202. The parser 203 may parse the header of each of the encoded frames, and generate a parsing start signal as it begins parsing the header of a frame. According to a result of a parsed header, the parser 203 may generate droppable frame reference information corresponding to the frame (details to be given shortly). The decoder 220 may access the encoded frames, and determine whether to decode an encoded frame for further display, or drop an encoded frame instead of decoding (details to be given with process 600 shortly). When the decoder 220 decodes a frame, a decoding complete signal is generated when the decoding is completed, and the decoded frame is buffered in the frame buffer 207 and then outputted to a screen (not shown) from the frame buffer 207 for display. When an encoded frame has been decoded by the decoder 220, the performance monitor 205 calculates the decoding time according to the parsing start signal and the decoding complete signal (details to be given with process 300 shortly), and accordingly generates a performance indicator.

Operations of the performance indicator 205, the dropping decider 206 and the droppable frame detector 204 are described below. When the parser 203 parses the header of a current frame and generates the corresponding droppable frame reference information, the performance monitor 205 generates a performance indicator according to the decoding time of at least one previous frame, and the dropping decider 206 generates a dropping decision according to the performance indicator (details to be given with process 300 shortly). The previous frame refers to a frame that is arranged before the current frame in the video bitstream, and the dropping decision indicates whether to drop a frame. On the other hand, the droppable frame detector 204 generates a droppable result according to the droppable frame reference information of the current frame (details given with processes 400 and 500 shortly). The droppable result indicates whether the current frame is droppable. The decoder 220 then determines whether to drop instead of decoding the current frame according to the dropping decision and the droppable result.

As shown by the process 300 in FIG. 3, operations of the performance monitor 205 and the dropping decider 206 are described in the steps below.

In step 301, in response to a parsing start signal which is generated as the parser 203 starts parsing a header of a frame P(c), the performance monitor 205 starts timing.

In step 302, the performance monitor 205 performs step 303 when the decoder 220 receives a decoding complete signal, or else step 305 is performed. Receiving decoding complete signal means that the decoder 220 has decoded the frame P(c).

In step 303, in response to the decoding complete signal which is generated when the decoder 220 completes decoding the frame P(c), the performance monitor 205 generates a decoding time T(c) (not shown) corresponding to the frame P(c) by stopping timing.

In step 304, according to the decoding time T(c) corresponding to the frame P(c), the performance monitor 205 calculates a moving average of the decoding time of at least one previous frame as a performance indicator I(c) (not shown). For example, assume that the frame count of the moving average is 3, the decoder 220 has sequentially decoded two frames P(a) and P(b) before the frame P(c), and the dropping decider 206 has generated decoding times T(a) and T(b) of the frames P(a) and P(b) respectively. After the frame P(c) is decoded, the performance indicator I(c) may be calculated as {T(a)+T(b)+T(c)}/3, or {w₁*T(a)+w₂*T(b)+w₃*T(c)}/(w₁+w₂+w₃), where w₁, w₂ and w₃ are weighting coefficients.

In one embodiment, the frame count of the moving average may equal to the number of frames buffered in the frame buffer 207, or may be set according to the number of frames buffered in the frame buffer 207. For example, the frame count of the moving average is increased as the number of frames buffered increases. When a video is to be played, the bitstream decoding circuit 210 allocates a buffer space in the frame buffer 207 according to the resolution of the video. For example, as the resolution gets higher, the buffer space may be allocated larger. Assume that the number of buffered frames is 3. When a frame is to be displayed, two frames with a display sequence subsequent to the frame have been also decoded and buffered in the frame buffer 207. That is, even if the decoding time of the frame is longer, if the decoding time of the two subsequent frames is short enough, the three frames can still be timely displayed. Thus, the average decoding time of every three frames may serve as a reference indicator for “whether timely display can be achieved”. The frame count of the moving average may be a constant number.

Alternatively, the performance indicator I(c) of the decoded frame P(c) may be calculated as {b1*I(b)+b2*T(c)}/(b1+b2), where b1 and b2 are weighting coefficients, and I(b) is the performance indicator previously generated from performing step 304 on the frame P(b).

In step 305, the performance monitor 205 keeps the performance indicator unchanged as it means that frame P(c) is not decoded when step 305 is performed after step 302. Assuming that the decoder 220 has decoded the frame P(b) and the dropping decider 206 has generated the performance indicator I(b) corresponding to the frame P(b) before the frame P(c) has been decoded, the performance indicator I(c) is equal to the previous performance indicator I(b) when step 305 is performed on the frame P(c).

Steps 306, 307 and 308 are described below. The dropping decider 206 receives the performance indicator I(c) which is generated by the performance monitor 205, and determines whether the performance indicator I(c) exceeds a predetermined range in step 306. When the performance indicator I(c) exceeds the predetermined range, the dropping decider 206 performs step 307 to generate a dropping decision indicating that it is needed to drop a frame. If not, the dropping decider 206 performs step 308 to generate a dropping decision indicating that it is not needed to drop a frame. In one embodiment, the predetermined range is a range that uses an ideal adjacent frame interval period T0 (in FIG. 1) as an upper limit. That is, it means that a decoding performance stress has occurred, the average decoding time of one single frame exceeds the period T0, and the frame cannot be timely displayed when the performance indicator is greater than the period T0. Thus, a dropping decision indicating that it is needed to drop a frame is generated. Conversely, it means that no decoding performance stress has occurred, and the average decoding time of one single frame is sufficient to support ideal display when the performance indicator is smaller than the period T0. Thus, a dropping decision indicating that it is not needed to drop a frame is generated.

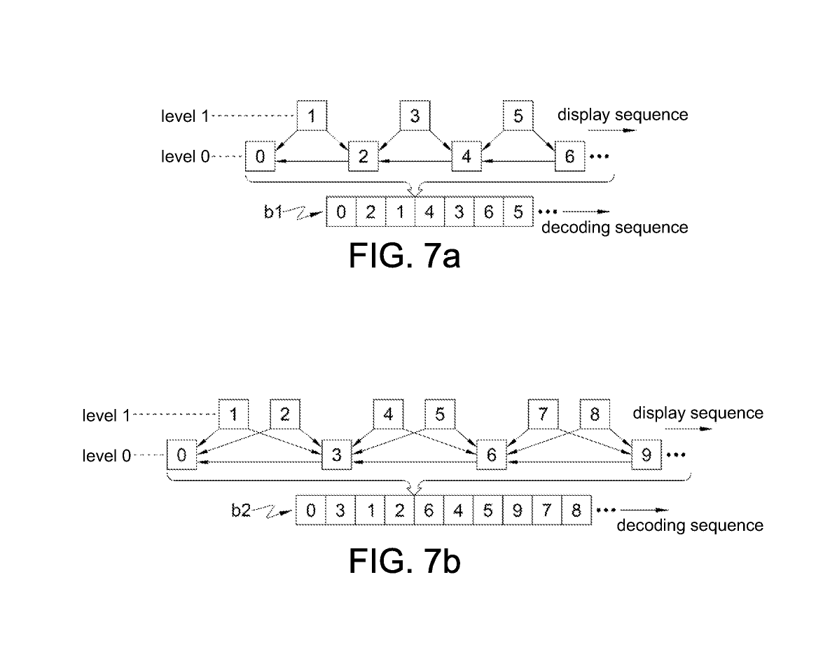

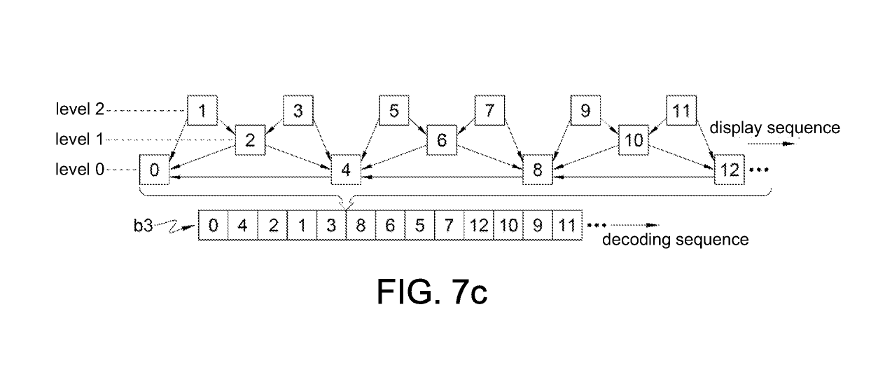

It is known from the process 300 that, the performance monitor 205 may dynamically generate the performance indicator according to the frame decoding time, and the dropping decider 206 adaptively determines whether it is need to drop a frame according to the performance indicator, so as to maintain the playback smoothness. Nonetheless, even when the dropping decider 206 has decided it is needed to drop a frame, as frames are cross-referenced when encoded into the video bitstream, the droppable frame detector 203 is needed to further determine whether a frame is droppable according to the cross-reference relationships among the frames. FIG. 7a to FIG. 7c are examples of different cross-reference relationships.

In FIG. 7a, a video bitstream b1 includes frames 0 to 6, and the frames 0, 1, 2, 3, 4, 5 and 6 are sequentially displayed during a playback process. The frame 0 is an intra frame, the frames 2 and 4 are predictive frames, and the frames 1, 3 and 5 are bi-predictive frames. The frame 2 is encoded by referring to the frame 0; that is, the frame 0 needs to be decoded before decoding the frame 2. Similarly, the frame 4 refers to the frame 2, and the frame 6 refers to the frame 4. The frame 1 is encoded by referring to the frames 0 and 2; that is, before decoding the frame 1, the frames 0 and 2 need to be decoded, and the frame 1 is then decoded according to the decoded frames 0 and 2. Similarly, the frame 3 refers to the frames 2 and 4, and the frame 5 refers to the frames 4 and 6. According to the reference relationships, the frames 0, 2, 4 and 6 are level-0 frames, and the frames 1, 3 and 5 are level-1 frames. If a lower level frame (e.g., level-0 frame 2) is not decoded, a higher level frame (e.g., level-1 frame 1 or 3) cannot be decoded. In contrast, if a higher level frame (e.g., level-1 frame 1 or 3) is dropped instead of being decoded, decoding a lower level frame (e.g., level-0 frame 2) is not affected.

In the bitstream b2 shown in FIG. 7b, the frame 3 refers to the frame 0, both of the frames 1 and 2 refer to the frames 0 and 3, the frame 6 refers to the frame 3, and both of the frames 4 and 5 refer to the frames 3 and 6. Thus, the frames 0, 3, 6 and 9 are level-0 frames, and the frames 1, 2, 4, 5, 7 and 8 are level-1 frames. In the bitstream b3 shown in FIG. 7c, the frame 4 refers to the frame 0, the frame 2 refers to the frames 0 and 4, and the frames 1 refers to the frames 0 and 2. Thus, the frames 0, 4, 8 and 12 are level-0 frames, the frames 2, 6 and 10 are level-1 frames, and the frames 1, 3, 5, 7, 9 and 11 are level-2 frames.

The header of a frame records information associated with the frame reference relationships. When the parser 203 parses the header of a frame, the associated information is reflected in the droppable frame reference information corresponding to the frame. For example, in some video bitstreams, the header of the frames record the temporal identification (ID) of the frames to indicate the frame level. For such bitstreams, the operations of the parser 203 and the droppable frame detector 204 may be illustrated by the process 400 shown in FIG. 4 as follow.

In step 401, following the frame P(c) in the process 300, a subsequently arranged frame P(d) in the video bitstream becomes the current frame. When the parser 203 parses the header of the frame P(d) and generates the corresponding droppable frame reference information, the parser 203 uses the temporal ID of the frame P(d) as the droppable frame reference information, and sends the temporal ID of the frame P(d) to the droppable frame detector 204.

Steps 402, 403 and 404 are as below. In step 402, the droppable frame detector 204 determines whether the temporal ID of the frame P(d) satisfies a predetermined condition. When the temporal ID satisfies the predetermined condition, the droppable frame detector 204 performs step 403 to generate a droppable result indicating that the frame P(d) is droppable. Conversely, when the temporal ID does not satisfy the predetermined condition, the droppable frame detector 204 performs step 404 to generate a droppable result indicating that the frame P(d) is not droppable. In one embodiment, the predetermined condition may be that the frame level is the highest level of the video bitstream, because dropping the frames of the highest level does not affect the decoding of the frames of lower levels.

Taking the bitstream b1 shown in FIG. 7a for instance, the predetermined condition may be that the frame is a level-1 frame. In this condition, if the frame P(d) is a level-1 frame (e.g., the frame 1, 3 or 5), the droppable frame detector 204 determines that the frame P(d) is droppable. Conversely, if the frame P(d) is not a level-1 frame (e.g., the frame 0, 2, 4 or 6), the droppable frame detector 204 determines that the frame P(d) is not droppable.

Similarly, taking the bitstream b2 shown in FIG. 7b for instance, the predetermined condition may be that the frame is a level-1 frame as well. In this condition, if the frame P(d) is a level-1 frame (e.g., the frame 1, 2, 4, 5, 7 or 8), the droppable frame detector 204 determines that the frame P(d) is droppable. Conversely, if the frame P(d) is a level-1 frame (e.g., the frame 0, 3, 6 or 9), the droppable frame detector 204 determines that the frame P(d) is not droppable.

For the bitstream b3 shown in FIG. 7c, in one embodiment, the predetermined condition may be that the frame is a level-2 frame. In this condition, if the frame P(d) is a level-2 frame (e.g., the frame 1, 3, 5, 7, 9 or 11), the droppable frame detector 204 determines that the frame P(d) is droppable. If the frame P(d) is a level-0 or level-1 frame (e.g., the frame 0, 2, 4, 6, 8, 10 or 12), the droppable frame detector 204 determines that the frame P(d) is not droppable.

For the bitstream b3 shown in FIG. 7c, in another embodiment, the predetermined condition may be that the frame is a level-1 or level-2 frame. In this condition, if the frame P(d) is a level-1 or a level-2 frame (e.g., the frame 1, 2, 3, 5, 6, 7, 9, 10 or 11), the frame P(d) is determined as a droppable frame. Conversely, if the frame P(d) is not a level-1 or a level-2 frame (e.g., the frame 0, 4, 8 or 12), the frame P(d) is not determined as a droppable frame.

In some other video bitstream, the header of the frame includes a reference frame indicator for indicating whether these frames are non-reference frames. When a frame is a non-reference frame, it means that the frame is not referred by other frames. In other words, even that frame is dropped instead of being decoded; the decoding of other frames is not affected. For example, the frames 1, 3, and 5 in the video bitstream b1, the frames 1, 2, 4, 5, 7 and 8 in the video bitstream b2, and the frames 1, 3, 5, 7, 9 and 11 in the video bitstream b3 are not reference frames. For bitstreams that carry reference frame indicator in the frame header, operations of the parser 203 and the droppable frame detector 204 may be illustrated with the process 500 in FIG. 5 as below.

In step 501, following the frame P(c) in the process 300, a subsequently arranged frame P(d) in the video bitstream becomes the current frame. When the parser 203 parses the header of the frame P(d) and generates the corresponding droppable frame reference information, the parser 203 utilizes the reference frame indicator of the frame P(d) as the droppable frame reference information, and sends the reference frame indicator of the frame P(d) to the droppable frame detector 204.

Steps 502, 503 and 504 are as below. In step 502, the droppable frame detector 204 determines whether the reference frame indicator of the frame P(d) indicates that the frame P(d) is a non-reference frame. When the reference frame indicator indicates that the frame P(d) is a non-reference frame, the droppable frame detector 204 performs step 503 to generate a droppable result indicating that the frame P(d) is droppable. Conversely, when the reference frame indicator indicates that the frame P(d) is a reference frame, the droppable frame detector 204 performs step 504 to generate a droppable result indicating that the current frame is not droppable.

After the droppable frame detector 204 generates the droppable result according to the droppable frame reference information of the frame P(d) (e.g., the process 400 or 500), and the dropping decider 206 generates the dropping decision according to the performance indicator I(c) (e.g., the process 300), the decoder 220 determines whether to drop the frame P(d) according to the dropping decision and the droppable result. As shown in FIG. 6, the process 600 includes steps 601, 602 and 603. In step 601, the decoder 220 determines whether need to drop according to the dropping decision and whether the current frame (e.g., the frame P(d)) is droppable according to the droppable result. When the dropping decision indicates that it is needed to drop a frame and the droppable result indicates that the current frame is droppable, the decoder 220 performs step 602 to drop instead of decoding the current frame, or else the decoder 220 performs step 603 to start decoding the current frame.

Technical effects of the present invention are given below. For example, when playing a video including 8522 frames at an ideal display speed of 60 frames per second, and decoding performance stress occurs for ⅔ of the time, only 4142 frames are timely displayed if the technical solution of the present invention is not adopted, such that the video playback cannot be carried out smoothly. In comparison, when the technical solution of the present invention is adopted, 1743 frames are dropped but the remaining 6779 frames could be timely displayed, such that the video could be played smoothly. In one embodiment, the droppable frame detector 204 may utilize different determination principles for determining whether the current frame is droppable. Each of the determination principles is selected according to a value range to which the performance indicator belongs. For example, if a performance indicator representing one single frame decoding time is greater than the period T0 (FIG. 1) but smaller than twice the period 2*T0 (i.e., belonging to a first value range), the droppable frame detector 204 determines whether the current frame is droppable by determining whether the frame level of the current frame is the highest level (i.e., the first determination principle) according to the temporal ID of the current frame. If the performance indicator representing one single frame decoding time is greater than twice the period 2*T0 (i.e., belonging to the second value range), the droppable frame detector 204 determines whether the current frame is droppable by determining whether the frame level of the current frame is the highest level or the second highest level (i.e., the second determination principle) according to the temporal ID of the current frame.

Taking the video bitstream b3 in FIG. 7c for instance, if the performance indicator is in the first value range, the droppable frame detector 204 determines that the frames 1, 3, 5, 7, 9 and 11 of the highest level are droppable. If the decoding performance is further in shortage such that the performance indicator is in the second value range, the droppable frame detector 204 determines that the frames 1, 2, 3, 5, 7, 9, 10 and 11 of the highest level and the second highest level are droppable. Thus, more frames are dropped when the performance indicator is in the second value range than in the first value range.

In one embodiment, not limited to the temporal ID and the reference frame indicator, the droppable frame detector 204 may also determine whether the current frame is droppable according to other information in the header of the current frame. In some video bitstreams, although not including the temporal ID or the reference frame indicator, the header of each frame may include reference information that record which frames are referred and the reference information may then serve as the droppable frame reference information. Associated technical details may be referred from the Taiwan Patent Application No. 104139947.

In one embodiment, the droppable frame information that the parser 203 provides for the current frame may be one single type of information (e.g., the temporal ID or the reference frame indicator), or may include multiple types of information, and the droppable frame detector 204 may integrate all the information to accordingly determine whether the current frame is droppable. For example, the droppable frame information may include the temporal ID and the display sequence of the current frame, and the droppable frame detector 204 collectively determines whether the current frame is droppable according to the temporal ID s and the display sequence. Taking the bitstream b2 in FIG. 7b for instance, the droppable frame detector 204 may determine whether the current frame is droppable by determining whether the frame level of the current frame is the highest level and whether the current frame is the frame (3*i+1) in the display sequence. Accordingly, the current frame is determines as droppable if it is the frame 1, 4 or 7 of the level 1. The current frame is determined as not droppable if it is the frame 2, 5 or 8 of the level 1 or the frame 0, 3, 6 or 9 of the level 0.

In one embodiment, the performance monitor 205 may calculate the performance indicator according to not only the moving average of the decoding times of the previous frames, but also one or multiple types of information including power, power saving mode setting, decoding loading, memory bandwidth and processer usage. For example, after the decoder 220 decodes the frame P(c), the performance monitor 205 may obtain a memory bandwidth M(c) used for decoding from the decoder 220, and together consider memory bandwidths M(a) and M(b) used for decoding the two previous frames P(a) and P(b) to calculate the performance indicator I(c) as e1*{T(a)+T(b)+T(c)}/3+e2*{M(a)+M(b)+M(c)}/3, where e1 and e2 are combination coefficients. That is, the moving average of the memory bandwidth and the moving average of the decoding time are integrated to calculate the performance indicator.

In one embodiment, the decoder 220 drops the current frame P(d) (step 602 in FIG. 6) by means of causing the pointer in the bitstream buffer 202 to point to a next frame to be decoded in the video bitstream (e.g., the frame P(e), not shown), so as to skip and not decode the current frame.

In one embodiment of process 300 in FIG. 3, if the frame P(c) is dropped instead of being decoded, in step 305, the performance monitor 205 generates an estimated decoding time T′(c) for the undecoded frame P(c) and calculates the moving average of the decoding time T′(c) and the decoding times T′(a) and T′(b) of multiple previous frames P(a) and P(b) as the performance indicator I(c) (e.g., {T′(a)+T′(b)+T′(c)}/3). The decoding time T′(a), T′(b) and T′(c) of the frames P(a), P(b) and P(c) may be actual decoding time generated in step 303 (if the frame is decoded) or estimated decoding times (if the frame is dropped instead of being decoded).

For generating the estimated decoding time T′(c) for the undecoded frame P(c), the performance monitor 205 may statistically calculate and categorize the actual decoding times of multiple previous decoded frames of the frame P(c), and determine to which type the frame P(c) belongs to. For example, the performance monitor 205 statistically calculates the correlation between “bit counts of frames before decoding (memory space consumed) and “actual decoding times” for 100 decoded frames. Then, the decoded frames having top 10 bit counts before the decoding are categorized into a first type, and the average decoding time of these 10 decoded frames is used as the decoding time of this first type; the decoded frames having next top 10 bit counts before the decoding are categorized into a second type, and the average decoding time of these 10 decoded frames is used as the decoding time of this second type; and so forth. Accordingly, the performance monitor 205 may determine the type of frame P(c) according to the bit count of the frame P(c) before the decoding, and utilize the decoding time of that type as the estimated decoding time of the frame P(c).

In conclusion, when playing a video, the present invention calculates a performance indicator to dynamically monitor the decoding performance, and appropriately drops a part of the frames when decoding performance stress occurs, such that other frames may be timely displayed according to an ideal timing to prevent lagging in video playback caused by the performance stress.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for controlling bitstream decoding, the bitstream comprising a plurality of frames, the method comprising:
generating a performance indicator according to a decoding time of at least one previous frame;
generating a dropping decision according to the performance indicator, wherein the dropping decision indicates whether it is needed to drop a frame; and
determining whether to drop a current frame according to the dropping decision.

2. The method according to claim 1, wherein the step of generating the performance indicator according to the decoding time of the at least one previous frame comprises:
starting timing in response to a parsing start signal which is generated as a parser starts parsing a header of a frame; and
generating the decoding time of the frame by stopping timing in response to a decoding complete signal which is generated as a decoder completes decoding the frame.

3. The method according to claim 1, wherein the step of generating the performance indicator according to the decoding time of the at least one previous frame comprises:
calculating a moving average of the decoding time of the at least one previous frame as the performance indicator according to the decoding time of the frame.

4. The method according to claim 1, wherein the step of generating the dropping decision according to the performance indicator comprises:
generating the dropping decision indicating that it is needed to drop a frame when the performance indicator exceeds a predetermined range.

5. The method according to claim 1, further comprising:
parsing a header of the current frame to generate droppable frame reference information of the current frame; and
generating a droppable result according to the droppable frame reference information, wherein the droppable result indicates whether the current frame is droppable;
wherein, the step of determining whether to drop the current frame according to the dropping decision comprises: determining whether to drop the current frame according to the dropping decision and the droppable result.

6. The method according to claim 5, wherein the droppable frame reference information is a temporal identification (ID), and the step of generating the droppable result according to the droppable frame reference information of the current frame comprises:
generating the droppable result indicating that the current frame is droppable when the temporal ID satisfies a predetermined condition; and
generating the droppable result indicating that the current frame is not droppable when the temporal ID does not satisfy the predetermined condition.

7. The method according to claim 5, wherein the droppable frame reference information is a reference frame indicator that indicates whether the current frame is a reference frame, and the step of generating the droppable result according to the droppable frame reference information of the current frame comprises:
generating the droppable result indicating that the current frame is droppable when the reference frame indicator indicates that the current frame is not the reference frame; and
generating the droppable result indicating that the current frame is not droppable when the reference frame indicator indicates that the current frame is the reference frame.

8. A bitstream decoding circuit, applied to a bitstream comprising a plurality of frames, the bitstream decoding circuit comprising:
a performance monitor, generating a performance indicator according to a decoding time of at least one previous frame;
a dropping decider, generating a dropping decision according to the performance indicator, wherein the dropping decision indicates whether it is needed to drop a frame; and
a decoder, determining whether to drop a current frame according to the dropping decision.

9. The bitstream decoding circuit according to claim 8, further comprising a parser, wherein an operation of the performance monitor generating the performance indicator according to the decoding time of the at least one previous frame comprises:
starting timing in response to a parsing start signal which is generated as a parser starts parsing a header of a frame; and
generating the decoding time of the frame by stopping timing in response to a decoding complete signal which is generated as a decoder completes decoding the frame.

10. The bitstream decoding circuit according to claim 8, wherein an operation of the performance monitor generating the performance indicator according to the decoding time of the at least one previous frame comprises:
calculating a moving average of the decoding time of the at least one previous frame as the performance indicator according to the decoding time of the frame.

11. The bitstream decoding circuit according to claim 8, wherein an operation of the dropping decider generating the dropping decision according to the performance indicator comprises:
generating the dropping decision indicating that it is needed to drop a frame when the performance indicator exceeds a predetermined range.

12. The bitstream decoding circuit according to claim 8, further comprising:
a parser, parsing a header of the current frame to generate droppable frame reference information of the current frame; and
a droppable frame detector, generating a droppable result according to the droppable frame reference information, wherein the droppable result indicates whether the current frame is droppable;
wherein, an operation of the decoder determining whether to drop the current frame according to the dropping decision comprises: determining whether to drop the current frame according to the dropping decision and the droppable result.

13. The bitstream decoding circuit according to claim 12, wherein the droppable frame reference information is a temporal identification (ID), and an operation of the droppable frame detector generating the droppable result according to the droppable frame reference information of the current frame comprises:
generating the droppable result indicating that the current frame is droppable when the temporal ID satisfies a predetermined condition; and
generating the droppable result indicating that the current frame is not droppable when the temporal ID does not satisfy the predetermined condition.

14. The bitstream decoding circuit according to claim 12, wherein the droppable frame reference information is a reference frame indicator that indicates whether the current frame is a reference frame, and an operation of the droppable frame detector generating the droppable result according to the droppable frame reference information of the current frame comprises:
generating the droppable result indicating that the current frame is droppable when the reference frame indicator indicates that the current frame is not the reference frame; and
generating the droppable result indicating that the current frame is not droppable when the reference frame indicator indicates that the current frame is the reference frame.
